(19) United States
(12) Patent Application Publication
(10) Pub. No.: US 2012/0066039 A1
(43) Pub. Date: Mar. 15, 2012

(54) METHOD AND SYSTEM FOR EVENT-TARGETED ADVERTISEMENT

(76) Inventor: Peter Ang, Voorhees, NJ (US)

(21) Appl. No.: 12/879,550

(22) Filed: Sep. 10, 2010

(51) Int. Cl. G06Q 30/00

(52) U.S. Cl. 705/14.5; 705/14.49

(57) ABSTRACT

The event-driven advertisement is targeted to a certain group of potential buyers who actually have needs for obtaining goods, material, products and or services. The buyers indicate these needs in terms of separate reminder items or entries in a reminder list which will be later reminded to the buyers in various manners. The sellers register their for-sale items such as goods, materials, products and services. Upon detecting any occurrence of the predetermined trigger conditions, if the reminder service identified one or more of the buyers and one or more of the reminder items, the identified buyers would be reminded of the identified reminder items with some seller information on the for-sale items that substantially match the identified reminder items. Depending upon the buyer control and preference, the reminder is optionally delivered with or without advertisement and or incentive to obtain goods, products and services from a particular registered seller. The incentives are generally negotiated by the intermediary agent in advance on behalf of the buyers and typically include discounts, coupons, rebates and other promotions.

Embodiments described herein generally relate to a system for event-driven targeted advertisement and a method of operating the same.

### BACKGROUND

People have integrated the use of computers into their daily lives, and one example includes calendar software applications for scheduling events and appointments. Using these software applications, people often rely upon a reminder function to remind themselves of these events and appointments. The reminder function is effective particularly with recent mobile devices such as tablets, smartphones, notebooks, and personal digital assistants (PDAs) since the users may be continuously reminded as they carry these mobile devices all the time. On the other hand, the reminder function is rather limited to personal use based upon date and time.

To enhance the reminder function, prior art has attempted to incorporate other hardware such as radio frequency identification (RFID) tags and global positioning system (GPS). These hardware devices provide the users with an additional feature in reminding of the items according to locations. For example, since the locations include store locations, if a user enters into a predetermined store carrying a mobile device with a location detection capability, the user is reminded of a particular item associated with the store. Thus, the reminder function has been enhanced as it is triggered by a combination of time/date and location.

Other people may want to have additional features that are not yet available in the reminder technology field. In addition to information on the items, events and appointments that the users have inputted themselves in a reminder system, the users are interested in obtaining other information that is not inputted by themselves, but related to the reminder items. Some prior art techniques have not yet reached a desirable level of efficiency and effects in these aspects.

### SUMMARY OF THE INVENTION

In order to solve the above and other problems, according to a first aspect of the current invention, a method of event-driven targeted advertisement, including the steps of: allowing buyers via a reminder service to register at least one reminder item to be reminded, each of the reminder items containing buyer information at least on an item name and being associated with conditions; allowing sellers via the reminder service to register for-sale items to be sold by the sellers, each of the for-sale items containing seller information at least on an item name and a price; storing the reminder items, the conditions and the for-sale items at a predetermined database of the reminder service; detecting an occurrence of at least one of the conditions; identifying in the database at least one of the buyers and at least one of the reminder items associated with the identified buyer for each of the detected conditions; matching the identified one of the reminder items and a substantially corresponding one of the for-sale items; and reminding each of the identified buyers of the identified reminder items with the seller information on the matched for-sale items according to the conditions.

According to a second aspect of the current invention, a method of event-driven targeted advertisement, including the steps of: recruiting buyers and sellers to a reminder service; allowing the buyers to author reminder items each associated with a certain set of conditions using the reminder service; storing the reminder lists at a predetermined database of the reminder service; detecting an occurrence of at least one of the conditions; identifying in the database at least one of the buyers and at least one of the reminder items based upon the detected one of the conditions; providing selected ones of the sellers with information on the identified one of the buyers and the identified one of the reminder items; and reminding the identified one of the buyers of the identified one of the reminder items from at least one of the selected sellers.

According to a third aspect of the current invention, a method of event-driven targeted advertisement, including the steps of: recruiting buyers and sellers to a reminder service; allowing the buyers to author reminder items each associated with certain conditions using the reminder service; allowing the sellers to register for-sale items using the reminder service; storing the reminder items, the conditions and the for-sale items at a predetermined database of the reminder service; detecting an occurrence of at least one of the conditions; identifying in the database at least one of the buyers, at least one of the reminder items and at least one of the for-sale items based upon the detected one of the conditions; and reminding the identified one of the buyers of the identified one of the reminder items and the identified one of the for-sale items.

According to a fourth aspect of the current invention, a method of event-driven targeted advertisement, including the steps of: negotiating incentives with sellers for buyers; allowing the buyers to author reminder items each associated with a certain set of conditions; storing the reminder items and the conditions at a predetermined database; detecting an occurrence of at least one of the conditions; identifying in the database at least one of the buyers and at least one of the reminder items based upon the detected one of the conditions; and reminding the identified one of the buyers of the identified one of the reminder items with the negotiated incentives.

According to a fifth aspect of the current invention, a system for event-driven targeted advertisement, including of: a reminder service unit for allowing buyers to register at least one reminder item to be reminded, each of the reminder items containing buyer information at least on an item name and being associated with conditions, the reminder service unit also allowing sellers to register for-sale items to be sold by the sellers, each of the for-sale items containing seller information at least on an item name and a price; and a plurality of terminal units operationally connected to the reminder service unit for detecting and communicating an occurrence of at least one of the conditions, wherein the reminder service unit identifying in the database at least one of the buyers and at least one of the reminder items associated with the identified buyer for each of the detected conditions, the reminder service unit matching the identified one of the reminder items and a substantially corresponding one of the for-sale items, the reminder service unit reminding each of the identified buyers of the identified reminder items with the seller information on the matched for-sale items according to the conditions.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating an exemplary embodiment of an event-driven targeted advertisement system according to the current invention.

FIG. 2 is a flow chart illustrating steps or acts involved in an exemplary process or method according to the current invention.

FIG. 3 is a flow chart illustrating additional steps or acts in the recruiting step S100 of FIG. 2 for recruiting buyers and sellers for the reminder service.

FIG. 4A has two tables illustrating exemplary data structures or records for the buyers as used in one method of event-driven targeted advertisement according to the current invention.

FIG. 4B is a table illustrating an exemplary data structure or record for the reminder items as used in one method of event-driven targeted advertisement according to the current invention.

FIG. 4C is a table illustrating an exemplary data structure or record for the trigger conditions as used in one method of event-driven targeted advertisement according to the current invention.

FIG. 4D is a table illustrating an exemplary data structure or record for the delivery conditions as used in one method of event-driven targeted advertisement according to the current invention.

FIG. 5A has two tables illustrating exemplary data structures or records for the sellers as used in one method of event-driven targeted advertisement according to the current invention.

FIG. 5B is a table illustrating an exemplary data structure or record for the for-sale items as used in one method of event-driven targeted advertisement according to the current invention.

FIG. 5C is a table illustrating an exemplary data structure or record for advertisement (AD) as used in one method of event-driven targeted advertisement according to the current invention.

### DETAILED DESCRIPTION

Embodiments of the event-driven targeted advertisement according to the current invention include processes, methods and systems. In general, the event-driven advertisement is targeted to a certain group of potential buyers who actually have needs for obtaining goods, material, products and or services. The buyers indicate these needs in terms of separate reminder items or entries in a reminder list which will be later reminded to the buyers in various manners. In further detail, each of the buyers optionally creates multiple reminder lists where relevant items are grouped according to their relevance, and each reminder item or entry optionally has certain predetermined conditions to trigger a reminder as well as certain other predetermined conditions to specify how the reminder is delivered.

In addition to the buyers with their reminder items, an exemplary event-driven targeted advertisement also involves sellers who register their for-sale items such as goods, materials, products and services. Upon detecting any occurrence of the predetermined trigger conditions, if the reminder service identified one or more of the buyers and one or more of the reminder items, the identified buyers would be reminded of the identified reminder items with some seller information on the for-sale items that substantially match the identified reminder items. According to one aspect of the invention, an intermediary agent or a reminder service offers the reminders with or without any human intervention. According to another aspect of the invention, the sellers deliver the reminders. Furthermore, the reminder is optionally made with or without any incentive to obtain goods, products and services from a particular registered seller. The incentives are generally negotiated by the intermediary agent in advance on behalf of the buyers and typically include discounts, coupons, rebates and other promotions.

To perform the exemplary event-driven targeted advertisement, one exemplary embodiment of the event-driven targeted advertisement system according to the current invention includes a reminder service unit for allowing the buyers to store one or more reminder items to be reminded according to certain conditions and for allowing the sellers to store for-sale items and some seller information to be offered to the buyers. The exemplary embodiment of the event-driven targeted advertisement system also includes a plurality of terminal units for the buyers to enter reminder items and their conditions as well as to receive the reminders. In general, the reminder service unit monitors the predetermined conditions that are associated with the reminder items. Upon detecting an occurrence of the predetermined conditions, the reminder service unit selectively reminds a particular buyer of the reminder items via the terminal unit or some other specified means. The reminder also optionally includes additional seller information on for-sale items that substantially match the reminder items according to the delivery conditions.

The above general description is a mere illustration of the current invention and does not limit the invention in any manner. By the same token, without limiting the current invention, more detailed examples will be described with respect to the following embodiments of the event-driven targeted advertisement.

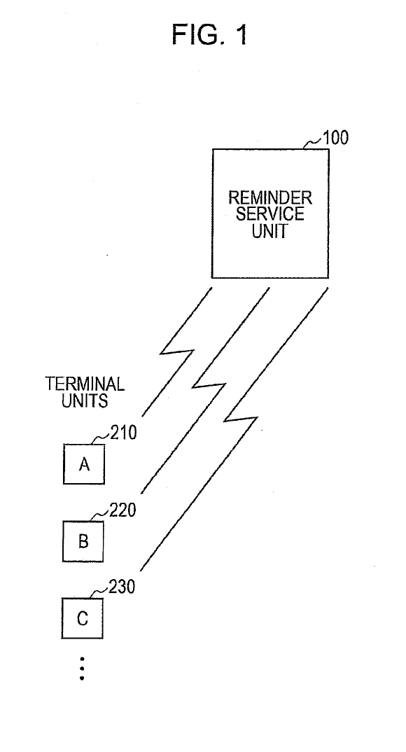

Referring now to the drawings, wherein like reference numerals designate corresponding structures throughout the views, and referring in particular to FIG. 1, a diagram illustrates an exemplary embodiment of an event-driven targeted advertisement system according to the current invention. The exemplary embodiment includes a reminder service unit 100 and a plurality of terminal units 210, 220 and 230. Although the exemplary embodiment illustrates only one reminder service unit 100 and three terminal units 210, 220 and 230, the exemplary embodiment is not limited to a particular number combination of these of units. In fact, both the reminder service unit 100 and the terminal units 210, 220 and 230 are optionally implemented in any number. The connection between the reminder service unit 100 and each of the terminal units 210, 220 and 230 is also implemented in various ways to communicate with each other. Exemplary communication includes wireless voice/data networks such as cellar networks and wired voice/data networks such as fiber optics networks.

The reminder service unit 100 is operationally connected to each of the terminal units 210, 220 and 230 in an event-driven targeted advertisement system. The reminder service unit 100 is a computing device with a memory storage for allowing certain registered buyers to store at least one reminder item to be reminded during their authorized access. In general, each of the reminder items contains buyer information such as an item name, an item type and some other optional information. For example, the buyers select an item name from predetermined lists of products, goods, services and materials during a reminder item entry. Similarly, the buyers select an item type from predetermined lists of types that classify categories of products, goods, services and materials. The reminder items optionally contain any other information in text format. The buyers enter the above information in the reminder service unit 100 via the terminal units 210, 220 and 230 or any computing device by accessing a certain Internet website that is associated with the reminder service unit 100. In addition, the buyers optionally enter the above information in the reminder service unit 100 via telephone with or without human intervention.

Each of the reminder items is optionally associated with certain predetermined conditions for the reminder service. The conditions include any combination of trigger conditions and delivery conditions. In general, the trigger conditions trigger to notify a particular buyer a particular reminder item that is associated with a specific set of the trigger conditions. Furthermore, trigger conditions include any combination of locations, time/dates and predetermined occasions. For example, the locations include any combination of GPS coordinates, predetermined stores and predetermined proximity criteria. If a buyer registered a reminder item such as a water filter for a water dispenser on a refrigerator door and associated the reminder item with Home Depot® as a trigger condition, the buyer would be reminded of the water filter via a terminal unit as she enters into a Home Depot® store. Similarly, the predetermined occasions include certain custom events that are each associated with specific location, time and or date. For example, a buyer creates an occasion entitled as “Our Wedding Anniversary” and associates the newly created occasion with a specific date to be reminded each year. It is also possible to use an occasion as a condition for reminding a product purchase.

The delivery conditions generally control how reminders are delivered to the buyers. Since each reminder item is associated with a specific set of the delivery conditions, the reminders are optionally delivered to a particular buyer. In details, the delivery conditions include any combination of an address, a device, privacy, frequency, priority and a preference for the seller information. For example, the addresses include any combination of an e-mail address, a telephone number and a street address while the devices include a tablet, a smart phone, a cell phone, a lap top and a desk top. Other delivery conditions such as privacy, frequency and priority specify a level of the reminder delivery. For example, if a level of privacy were set high for a particular reminder item, the sellers have no access to the information pertaining to the reminder item. A level of frequency is also specified for a particular reminder item by selecting a certain level such as weekly and daily. Another example of the delivery condition is a preference for the seller information, which determines how much advertisement the buyer receives from the seller for the reminder item. If a buyer registered a reminder item such as a Pure® water filter and associated the reminder item with no advertisement for the seller information as a delivery condition, the buyer would be reminded of the Pure® water filter without receiving any advertisement for water filters from other brands.

The reminder service unit 100 also allows registered sellers to input for-sale items to be sold by the sellers. Each of the for-sale items contains seller information at least on an item name and a price. In general, each of the for-sale items optionally contains other seller information such as an item type and some other optional information such as advertisement of other for-sale items that are related to a given for-sale item. For example, the sellers select an item name from predetermined lists of products, goods, services and materials during a for-sale item entry. Similarly, the sellers select an item type from predetermined lists of types that classify categories of products, goods, services and materials. The sellers enter the above information in the reminder service unit 100 via the terminal units 210, 220 and 230 or any computing device by accessing a certain Internet website that is associated with the reminder service unit 100. In addition, the sellers optionally enter the above information in the reminder service unit 100 via telephone with or without human intervention.

The seller information further includes other commercial messages and incentives for the for-sale items that the sellers register at the reminder service unit 100. For example, the seller information includes discounted prices of the for-sale items, coupons for the for-sale items and or frequent user points to be offered to the buyers by the sellers. The above exemplary seller information is delivered to the buyers from the sellers according to the conditions such as the delivery conditions that the buyers specify for each of the reminder items. That is, it is optionally determined for each of the reminder items whether or not the seller information is delivered to a particular buyer.

The reminder service unit 100 optionally stores any of the reminder items, the buyer information, the conditions, the for-sale items as well as the seller information in a predetermined database. Furthermore, the predetermined database is optionally under control of an intermediary agent. Alternatively, the terminal units 210, 220 and 230 or any other computing devices optionally store any of the reminder items, the buyer information, the conditions, the for-sale items as well as the seller information in a predetermined database. That is, the above information is optionally stored in distributed and or centralized storage locations such as the terminal units 210, 220 and 230 and the reminder service unit 100.

The exemplary embodiment of an event-driven targeted advertisement system according to the current invention further includes a plurality of terminal units 210, 220 and 230 that are operationally connected to the reminder service unit 100. As already described above, the terminal units 210, 220 and 230 are used to enter information in the reminder service unit 100. In addition, the terminal units 210, 220 and 230 are also used to detect and communicate an occurrence of at least one of the predetermined conditions. For example, while the buyers carry the terminal units 210, 220 and 230, the terminal units 210, 220 and 230 monitor their absolute coordinates by means of on-board GPS. Alternatively, RFID tags are installed at certain locations such as retail stores, and the terminal units 210, 220 and 230 identify the stores by reading information stored in the RFID tags. Upon detecting a specific location that is specified as one of the trigger conditions for a particular buyer, any of the terminal units 210, 220 and 230 notifies the reminder service unit 100 of the detected condition for a particular combination of the reminder item and the buyer.

In the exemplary embodiment of an event-driven targeted advertisement system according to the current invention, the reminder service unit 100 processes the notified condition from the terminal unit 210, 220 or 230. Initially, the reminder service unit 100 identifies in the database at least one of the buyers and at least one of the reminder items associated with the identified buyer for each of the notified conditions. Using a similar example from the previous paragraph, after a particular buyer A enters a can of soup as a reminder item and ShopRite® as a trigger condition in the reminder service unit 100, as the buy A enters a ShopRite® store with the terminal 210, the terminal 210 detects the trigger condition and notifies the reminder service unit 100 of the buyer A at ShopRite® and the can of soup.

In the exemplary embodiment of an event-driven targeted advertisement system according to the current invention, the reminder service unit 100 further processes the identified buyers and the identified reminder items. Based upon the above information, the reminder service unit 100 retrieves the delivery conditions of each of the identified reminder items for each of the identified buyers. In general, the retrieved delivery conditions of each of the identified reminder items specifies as to how the corresponding reminder should be delivered as well as what should be delivered. Still using the same previous example, if the retrieved delivery conditions of the can of soup specify only a reminder without any seller information, the reminder service unit 100 does not search for any seller information and delivers a simple reminder indicating the can of soup at ShopRite® to the buyer A. On the other hand, if the retrieved delivery conditions of the can of soup request the seller information, the reminder service unit 100 searches for any seller information and delivers a reminder indicating the can of soup at ShopRite® to the buyer A with the searched seller information.

In the exemplary embodiment of an event-driven targeted advertisement system according to the current invention, if the delivery conditions so specify, the reminder service unit 100 retrieves a relevant portion of the seller information such as a corresponding one of the for-sale items of the sellers. According to one exemplary embodiment, the reminder service unit 100 attempts to match the identified reminder items with a substantially corresponding one of the for-sale items of a particular seller. For example, although the identified reminder item generally includes a product name and or a product type, these pieces of information may not perfectly match with those of the for-sale items of the sellers. For this reason, the matching criteria are optionally flexible so that the buyers do not have to be exact in specifying the reminder items. Otherwise, the buyers cannot quickly enter the reminder items and have to spend more time than desired to enter the exact information. In this regard, if a substantial match is made, the reminder service unit 100 reminds each of the identified buyers of the identified reminder items with the seller information on the substantially matched for-sale items even if no exact match is found in some cases.

As described above, the seller information includes various incentives and useful information for the buyers in making a purchasing decision. For example, the seller information includes a comparison of the prices of the matched for-sale items in an embodiment of an event-driven targeted advertisement system according to the current invention. In another example, the seller information provides the buyers with additional information that is related to the matched for-sale items. Of course, the seller information is not provided to the buyers unless the buyers expressly agree in the delivery conditions or are defaulted to agree in some cases. That is, the reminder service unit 100 automatically filters the seller information based upon the delivery conditions of the identified buyers.

In addition to the above described embodiments of the event-driven targeted advertisement system, there are optional filtering mechanisms for providing the seller information with the buyers. For example, an intermediary agent of the reminder service manually filters the seller information. In another example, after the reminder service unit 100 informs the registered sellers of the identified buyers and the identified reminder items, the sellers selectively remind the identified buyers according to the delivered conditions.

Upon receiving the reminders, the terminal units 210, 220 and 230 provide the buyers with a user interface for purchasing the matched for-sale items in an embodiment of an event-driven targeted advertisement system according to the current invention. For example, when the buyers are reminded, the purchasing interface automatically leads the buyers to an internet web site of the sellers so as to allow the buyers to purchase the matched for-sale items. In another example, the interface assists the buyers to purchase the matched for-sale items at a store of the sellers by offering directions to the exact location such as an isle number where the buyer can find the matched for-sale items within the store.

In managing the reminder items, the terminal units 210, 220 and 230 provide the buyers with other user interface for organizing or editing the reminder items in an embodiment of the event-driven targeted advertisement system according to the current invention. For example, after the buyers purchase the matched for-sale items, the terminal units 210, 220 and 230 provide an interface to edit or remove the reminder items and the associated conditions. Furthermore, the interface optionally allows the buyers to organize the reminder items into one or more of reminder lists. Alternatively, after the buyers purchase the matched for-sale items, the terminal units 210, 220 and 230 automatically remove the corresponding reminder items based upon the conditions associated with the reminder items.

An embodiment of an event-driven targeted advertisement system according to the current invention also takes care of the charges or fees for the use of the reminder system. For example, the reminder service unit 100 charges the sellers a predetermined amount of fees. According to a first aspect, the fee structures include that the sellers pay the reminder service the fee based upon a number of the matched for-sale items. According to a second aspect, the sellers pay the reminder service the fee based upon the matched for-sale items that the buyers have purchased from the sellers. According to a third aspect, the reminder service unit 100 charges the buyers a fee. According to a fourth aspect, the buyers pay the reminder service the fee based upon a number of the matched for-sale items. According to a fifth aspect, the buyers pay the reminder service the fee based upon the matched for-sale items that the buyers have bought from the sellers. The fee structure according to the current invention is not limited to the above enumerated examples and includes other criteria and or mechanism to collect fees.

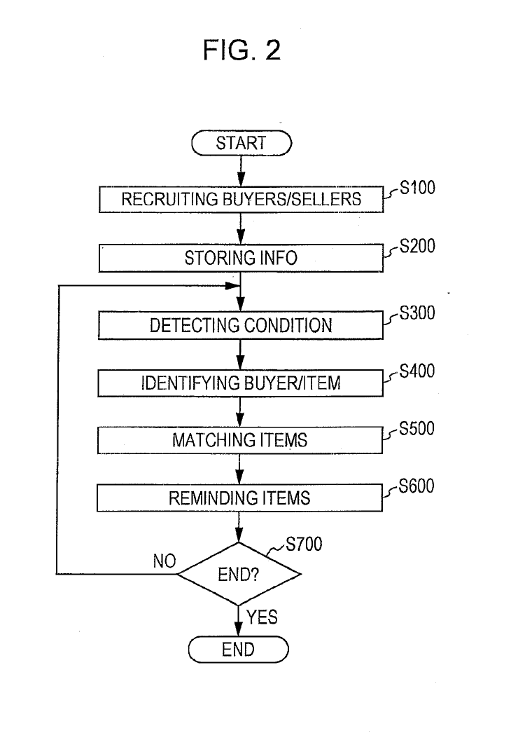

Now referring to FIG. 2, a flow chart illustrates steps or acts involved in an exemplary process or method according to the current invention. In general, the exemplary process may be described as an even-driven targeted advertisement based upon reminders. The exemplary process includes a step S100 for recruiting buyers and sellers for the reminder service. In the step S100, the buyers are allowed via a reminder service to register at least one reminder item to be reminded, and each of the reminder items contains buyer information at least on an item name and being associated with certain conditions. For example, the reminder items include any combination of products, material and services while the conditions include both trigger conditions and delivery conditions. Similarly, the recruiting step S100 also allows the sellers via the reminder service to register for-sale items to be sold by the sellers, and each of the for-sale items contains seller information at least on an item name and a price. In a step S200, the above inputted information is stored in a certain predetermined database of the reminder service, which is implemented in a combination of devices that are associated with the buyers and the sellers. In addition, the reminder service is optionally associated with an intermediary agent who works for the buyers and the sellers. The above steps S100 and S200 are repeated and or independently performed, and they are not limited by a particular sequence of events.

In a step S300, an occurrence of at least one of the conditions is detected in the exemplary process. Upon detecting any one of the conditions, at least one of the buyers is identified in the database, and at least one of the reminder items that is associated with the identified buyer is also identified in a step S400. For example, if the detected condition is a trigger condition such as a specified time by one of the buyers, the buyer who specified the detected condition is identified in the step S400. Subsequently, it is attempted to identify one of the reminder items that is associated with the identified buyer and or the specified time. The above identifications in the step S400 are performed for each of the detected conditions. In the exemplary process, the identification is made automatically without human intervention. Alternatively, the identification is made manually with human intervention by a person such as an intermediary agent.

After at least one of the buyers and at least one of the reminder items that is associated with the identified buyer are identified in the step S400, each of the identified reminder items is now matched with a substantially corresponding one of the for-sale items in a step S5S00. For example, the for-sale items such as drills of a particular seller are matched with the identified reminder item such as tools of the identified buyer in the step S500. In the exemplary process, the matching is made automatically without human intervention. Alternatively, the matching is made manually with human intervention by a person such as an intermediary agent.

Lastly, in a step S600, each of the identified buyers is reminded of the identified reminder items with the seller information on the matched for-sale items according to the delivery conditions. For example, after the for-sale items such as drills of a particular seller are matched with the identified reminder item such as tools of the identified buyer in the step S500, the step S600 ascertains that the identified buyer desires to have the seller information of the matched for-sale items of drills by checking the delivery conditions associated with the identified reminder item of tools. If the delivery conditions do not indicate that the identified buyer desires to have the seller information, simply the reminder item is reminded to the identified buyer. On the other hand, if the delivery conditions indicate that the identified buyer desires to have the seller information, the reminder item is reminded to the identified buyer with the seller information on the matched for-sale items. As will be further described below, the delivery conditions include additional conditions and limitations on the delivery of the seller information to the buyers.

Still referring to FIG. 2, a step S700 determines as to whether or not the above described steps and acts are to be repeated. In general, the exemplary even-driven targeted advertisement process will be repeated until one of predetermined termination conditions occur. In one embodiment, the detection step S300 is continuously performed to detect every condition. In another embodiment, the detection step S300 is optionally performed on a predetermined frequency such as hourly, daily or monthly based upon the step S700. Furthermore, the steps S300 and S700 are optionally performed on a different frequency for certain conditions. For example, in the step S300, the location detection is performed every minute while the holiday is checked on a daily basis.

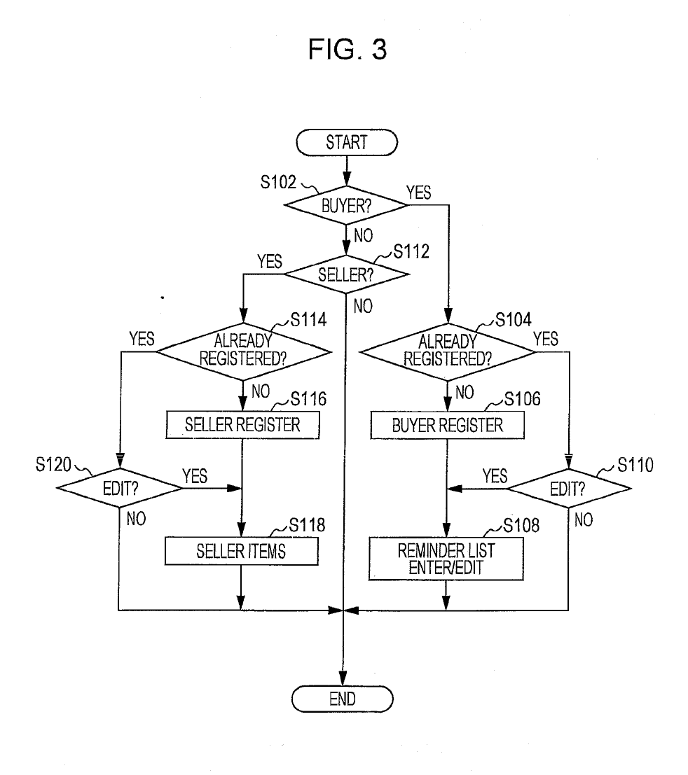

Now referring to FIG. 3, a flow chart illustrates additional steps or acts in the recruiting step S100 of FIG. 2 for recruiting buyers and sellers for the reminder service. If it is determined in a step S102 that a buyer is engaged in the recruiting step S100, it is further determined if the buyer has been already registered in the reminder service in a step S104. In case the buyer is not yet registered, the buyer is registered in a step S106 for opening an account and so on. The additional registration in a step S108 includes at least one reminder item to be reminded, and each of the reminder items contains buyer information at least on an item name and being associated with certain conditions. The step S108 also allows the registered buyer to edit the existing buyer information. On the other hand, if it is determined that the buyer has been already registered in the reminder service in the step S104, the registered buyer selects in a step S110 to proceed to the step S108 to edit the buyer information. The registered buyer can also select to not to edit at this time in the step S110 so that she can exit the process.

Still referring to FIG. 3, if it is determined in the step S102 that the buyer is not engaged, the process proceeds to a step S112, where it is determined whether or not a person is a seller. If it is determined in a step S112 that a seller is engaged in the recruiting step S100, it is further determined if the seller has been already registered in the reminder service in a step S114. In case the seller is not registered, the seller is registered in a step S116 to open a new account. The additional registration in a step S118 allows the seller to input for-sale items to be sold by the sellers, and each of the for-sale items contains seller information at least on an item name and a price. The step S118 also allows the registered seller to edit the seller information. On the other hand, if it is determined that the seller has been already registered in the reminder service in the step S114, the registered seller selects in a step S120 to proceed to the step S108 to edit the seller information. The registered seller can also select to not to edit at this time in the step S120 so that she can exit the process.

The above described steps and acts of the exemplary process further include additional steps or features. For example, the seller information includes discounted prices or coupons for the for-sale items. Alternatively, the seller information includes frequent user points to be offered to the buyers by the sellers. In general, the conditions include both trigger conditions and delivery conditions. Furthermore, the trigger conditions include any combination of locations, time/dates and predetermined occasions. For example, the locations include any combination of GPS coordinates, predetermined stores and predetermined proximity criteria. In another example, the predetermined occasions include events that are each associated with specific time and or date. In yet another example, the delivery conditions include any combination of an address, a device, privacy, frequency, priority and a preference for the seller information.

An exemplary method of event-driven targeted advertisement according to the current invention further includes an additional step for controlling certain aspects of the seller information delivery. One exemplary control is to automatically filtering the seller information based upon the delivery conditions of the identified buyers. For example, this means that even if there is seller information on the matched for-sale items, if the conditions such as delivery conditions do not specify the delivery of the seller information such as advertisement, the seller information will not be delivered to the identified buyers. In another example, the delivery conditions also specify how and or where the seller information on the matched for-sale items is delivered.

Other additional steps are controlled by involving a particular agent in the process. For example, the predetermined database is under control of an intermediary agent. In another case, the sellers are involved. In this case, the exemplary process includes an additional step of informing the sellers of the identified buyers and the identified reminder items. Subsequently, the sellers remind the identified buyers. In another example, the reminder service reminds the identified buyers.

Other steps are related to the buyer information. For example, the buyers are additionally provided with a comparison of the prices of the matched for-sale items. In another example, the buyers are additionally provided with an additional amount of the seller information that is related to but other than the matched for-sale items.

Yet other steps are related to the fee structure and charging fees. For example, the sellers are charged of a fee. In one fee structure, the sellers pay the reminder service the fee based upon a number of the matched for-sale items. In another fee structure, the sellers pay the reminder service the fee based upon the matched for-sale items that the buyers have bought from the sellers. In another example, the buyers are charged of a fee. In one fee structure, the buyers pay the reminder service the fee based upon a number of the matched for-sale items. In another fee structure, the buyers pay the reminder service the fee based upon the matched for-sale items that the buyers have bought from the sellers.

An exemplary method of event-driven targeted advertisement according to the current invention further includes an additional step of purchasing the matched for-sale items following the reminding step. In one situation, the buyers purchase the matched for-sale items at an internet web site of the sellers. In another situation, the buyers purchase the matched for-sale items at a store of the sellers.

An exemplary method of event-driven targeted advertisement according to the current invention further includes additional steps of handling the reminder items and the conditions. For example, the reminder items and the conditions are edited following the reminding step. Furthermore, the reminder items are automatically removed based upon the conditions following the reminding step. In another example, the reminder items are organized into one or more of reminder lists.

A first alternative process includes a first step of recruiting buyers and sellers to the reminder service. In a second step, the buyers are allowed to author reminder lists containing reminder items each associated with a certain set of conditions using the reminder service. For example, the reminder items include any combination of products, material and services while the conditions include both trigger conditions and delivery conditions. In a third step, the above reminder lists are stored in a certain predetermined database of the reminder service. In a fourth step, an occurrence of at least one of the conditions is being detected in the exemplary process. Upon detecting the conditions, at least one of the buyers is identified in the database, and at least one of the reminder items that is associated with the identified buyer is also identified in a fifth step. In a sixth step, selected ones of the sellers are provided with the information on the identified buyers and the identified reminder items. Lastly, in a seventh step, the identified buyers are reminded of the identified reminder items from at least one of the selected sellers.

A second alternative process includes a first step of recruiting buyers and sellers to the reminder service. In a second step, the buyers are allowed to author reminder items each associated with certain conditions using the reminder service. For example, the reminder items include any combination of products, material and services while the conditions include both trigger conditions and delivery conditions. Similarly, in a third step, the sellers are allowed to register for-sale items using the reminder service. In a fourth step, the reminder items, the conditions and the for-sale items are stored at a predetermined database of the reminder service. In a fifth step, an occurrence of at least one of the conditions is being detected in the exemplary process. Based upon the detected conditions, at least one of the buyers, at least one of the reminder items and at least one of the for-sale items are identified in a sixth step. In a seventh step, the identified reminder items and the identified for-sale items are reminded to the identified buyers.

A third alternative process includes a first step of negotiating incentives with the sellers for the buyers. In a second step, the buyers are allowed to author reminder items each associated with a certain set of conditions. For example, the reminder items include any combination of products, material and services while the conditions include both trigger conditions and delivery conditions. In a third step, the reminder items and the conditions are stored at a predetermined database. In a fourth step, an occurrence of at least one of the conditions is being detected in the exemplary process. Based upon the detected conditions, at least one of the buyers and at least one of the reminder items are identified in a fifth step. In a sixth step, the identified reminder items with the negotiated incentives are reminded to the identified buyers.

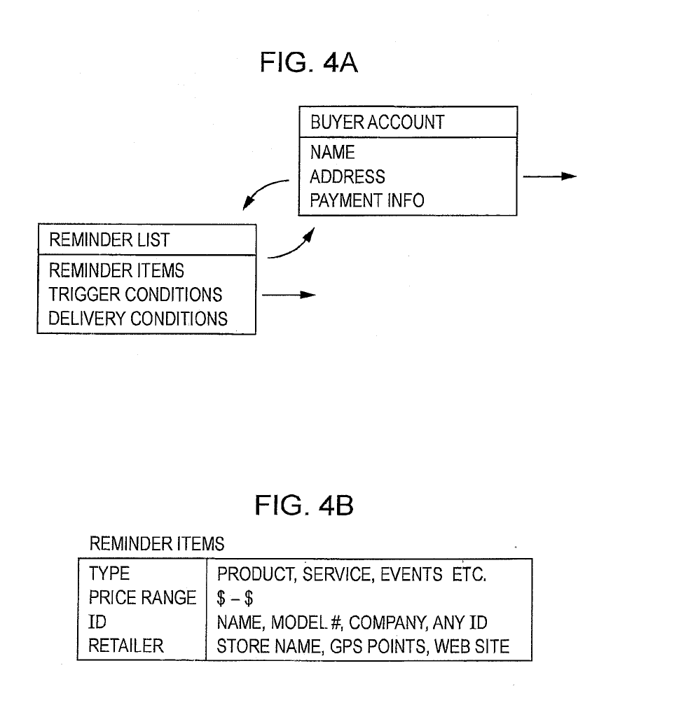

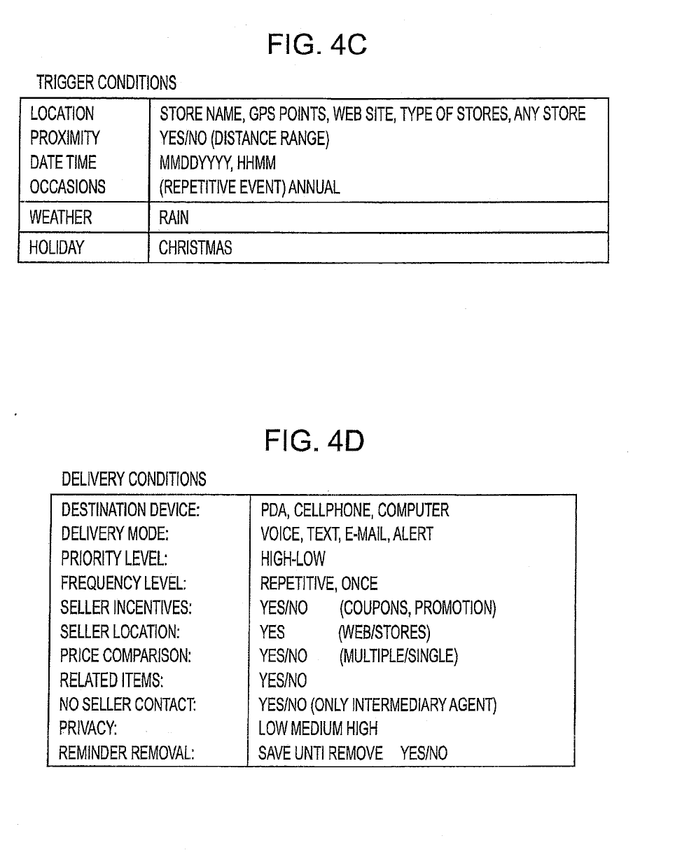

FIGS. 4A through 4D are tables illustrating exemplary data structures or records that the buyers maintain in one method of event-driven targeted advertisement according to the current invention. As already described with respect to the steps S100 and S200 of FIG. 2, the buyers enter and store the buyer information. The illustrated tables include the buyer information that the buyers register and or edit in the steps S106 and S108 of FIG. 3.

Now referring to FIG. 4A, two tables illustrate exemplary data structures or records for the buyers as used in one method of event-driven targeted advertisement according to the current invention. The buyer information generally includes a buyer account and a reminder list. The buyer account contains basic account information such as a buyer's name, address and payment information. The reminder list contains a reminder item, a trigger condition and a delivery condition. The trigger condition and or the delivery condition are individually associated with each of the reminder items. Although the reminder list table illustrates a single set of a reminder item, a trigger condition and a delivery condition, the reminder list table optionally contains multiple sets and or the list itself is multiplied to a plurality of the reminder list tables. These multiple tables are optionally implemented as linked lists, which are also optionally linked to the buyer account table as indicated by arrows.

In FIG. 4B, a table illustrates an exemplary data structure or record for the reminder items as used in one method of event-driven targeted advertisement according to the current invention. In one implementation, the reminder item table of FIG. 4B is an expanded view of the reminder item in the reminder list of FIG. 4A. For Example, each of the reminder items optionally includes any combination of a type, a price or a price range, an item ID and a retailer. The type further includes categories such as product, service, event and so on. The price or price range indicates a desired dollar amount or a desired range for a particular reminder item. The reminder item ID uniquely identifies a particular reminder item by any combination of a name, a model number, a manufacturer or a service provider and so on. The retailer specifies any number of the sellers that sells a particular reminder item. Although the reminder item table illustrates a single set of a type, a price or a price range, an item ID and a retailer, the reminder item table optionally contains multiple sets and or the reminder item table is multiplied to a plurality of reminder item tables. These tables are optionally implemented as linked lists, which are linked to the corresponding reminder list.

Still referring to FIG. 4B, certain entries of the exemplary data structure or record are optionally defaulted to a predetermined value for a reminder item as used in one method of event-driven targeted advertisement according to the current invention. For example, when the buyer enters a new reminder item, if no specific value is entered for the reminder value, a predetermined value is assigned as a default value. For example, the item ID can be defaulted to a predetermined value indicating any item ID.

In FIG. 4C, a table illustrates an exemplary data structure or record for the trigger conditions as used in one method of event-driven targeted advertisement according to the current invention. In general, the trigger condition specifies as to when an associated reminder item is actually reminded. Each of the trigger conditions is optionally specified by any combination of a location, proximity, date time, an occasion, a weather condition, a holiday and so on. For example, if a specified location such as particular GPS coordinates is detected, the associated reminder item is reminded to the buyer who entered the reminder item. In another example, a certain reminder is made if the associated proximity condition is satisfied by detecting a predetermined distance to the particular GPS coordinates. In this example, when the buyer is reminded of the reminder item in a first store at the particular GPS coordinates, the same buyer is notified of a second store which is within a predetermined distance from the first store.

Still referring to FIG. 4C, certain entries of the exemplary data structure or record are optionally defaulted to a predetermined value for a trigger condition as used in one method of event-driven targeted advertisement according to the current invention. For example, when the buyer enters a new reminder item, if no specific value is entered for a location value in trigger conditions, a predetermined value is assigned as a default value. For example, the location can be defaulted to a predetermined value indicating any location. In other words, any retail store location satisfies the location as a trigger condition.

An example is provided based upon defaulted values. If a buyer entered a simple reminder such as a water filter without specifying its ID in the reminder item table and a location in the trigger condition table, the ID value would be defaulted to any item ID while the location would be defaulted to any location. Consequently, the buyer would be reminded of an aquarium water filter in a pet store while the same buyer would be reminded of an appliance water filter or a water filter for a swimming pool in a home improvement store, provided that both the pet store and the home improvement store have been registered, and the respective sellers have registered the relevant for-sale items in the reminder system.

The trigger condition table also includes other entries for an occasion, a weather condition and a holiday. The occasion is a custom event that has a user-specified label such as a “wedding anniversary” that is associated with a specific date. A weather condition such as rainy forecast causes the reminder system to remind of a certain reminder item such as an umbrella. The information such as a weather condition may be provided by metadata in a (really simple syndication) RSS feed. A holiday condition is similar to an occasion except that the holidays such as Christmas are each associated with a predetermined date. Although the trigger condition table illustrates a single set of a location, proximity, date time, an occasion, a weather condition and a holiday, the trigger condition table optionally contains multiple sets and or the trigger condition table is multiplied to a plurality of trigger condition tables. These tables are optionally implemented as linked lists, which are linked to the corresponding reminder item.

In FIG. 4D, a table illustrates an exemplary data structure or record for the delivery conditions as used in one method of event-driven targeted advertisement according to the current invention. In general, the delivery conditions specify as to how an associated reminder item is reminded. The delivery conditions also specify the buyers' preference for additional seller information when a reminder is delivered for a reminder item. Each of the delivery conditions is optionally specified by any combination of a destination device, a delivery mode, a priority level, a frequency level, seller incentives, seller locations, price comparison, related items, no seller contact, a privacy level, reminder removal and so on. In one embodiment, the delivery conditions are optionally associated to each of the reminder items. In another embodiment, the delivery conditions are associated to all of the reminder items in the same manner.

Still referring to FIG. 4D, the delivery condition table is used in delivering the reminder items to the buyers. The reminder item is delivered to a destination device that the buyer has specified. For example, the destination devices include a combination of portable digital assistant (PDA), a cell phone, a computer and a dedicated reminder device while the delivery modes include a combination of a voice mail account, an e-mail message, a special alert and so on. In an exemplary implementation, a predetermined reminder software application is downloaded into a PDA, a cell phone and or a computer for receiving the delivery from the reminder system according to the current invention. The priority level is optionally specified to a predetermined level such as high or low using a mail application such as Microsoft Outlook. The frequency level is a desired frequency of reminder delivery and optionally includes a number of delivery such as daily and hourly.

The delivery condition table also specifies an amount of additional information that the buyers receive. When a reminder is delivered to a buyer, if the seller incentives specify “yes” in the delivery condition table of the buyer, the additional seller information such as coupons and promotions is also delivered to the buyer. The incentives from the seller are not necessarily related to a particular reminder item that the buyer is reminded according to the current invention. By the same token, as a reminder is delivered to a buyer, if the seller location indicates “yes” in the delivery condition table of the buyer, the seller's web site or store location is also delivered to the buyer. For example, the buyer receives a link to the seller's web site or the directions or map to the seller's store.

Other preferences such as price comparison and related items allow the seller to include a price comparison and related items in the reminder delivery. If the delivery condition table indicates that the buyer has turned on the price comparison, the seller is allowed to deliver additional information on price comparison. In one example, the price comparison is changes in the price of the reminder item over a course of a certain time period at the seller's store. In another example, the price comparison is prices of the reminder item among competitive sellers. Similarly, if the delivery condition table indicates that the buyer has turned on the related items, the seller is allowed to deliver additional information on additional items that are related to the reminder item. In one example, the related items are within the same category of the product and service. In another example, the related items are the for-sale items that the sellers sell within the same store where the reminded item is located.

Still referring to FIG. 4D, the buyers control an amount of the seller information in the reminder delivery in other preferences such as no seller contact and privacy level. If the delivery condition table indicates that the buyer has turned on the no seller contact option, no seller is allowed to deliver additional information. On the other hand, if the delivery condition table indicates that the buyer has not turned on the no seller contact option but indicated a high privacy choice in the privacy level, only a limited amount of the seller information is added to the reminder delivery.

Lastly, the delivery condition table further includes reminder removal preference for the buyer to control the reminder item after the reminder item has been delivered to the buyer. For example, after a particular reminder item has been reminded to the buyer, the reminder item is automatically removed from the reminder list if the buy has indicated in the reminder removal preference “automatic removal” for the delivered reminder item. On the other hand, the reminder item remains in the reminder list if the buy has indicated “save until remove” in the reminder removal preference for the reminder item.

Although the delivery condition table illustrates a single set of a destination device, a delivery mode, a priority level, a frequency level, seller incentives, seller locations, price comparison, related items, no seller contact, a privacy level, reminder removal, the delivery condition table optionally contains multiple sets and or the delivery condition table is multiplied to a plurality of delivery condition tables. These tables are optionally implemented as linked lists, which are linked to the corresponding reminder item.

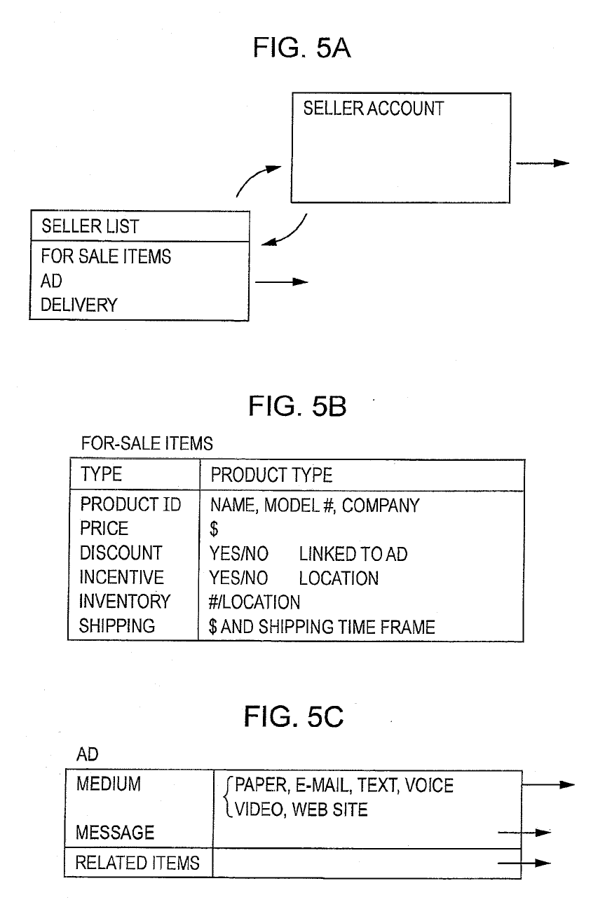

Now referring to FIG. 5A, two tables illustrate exemplary data structures or records for the sellers as used in one method of event-driven targeted advertisement according to the current invention. The seller information generally includes a seller account and a seller list. The seller account contains basic account information such as a seller's name, address and store information. The seller list contains for-sale items, advertisement (AD) and a delivery condition. The AD and or the delivery condition are individually associated with each of the for-sale items. Although the seller list table illustrates a single set of a for-sale item, AD and a delivery condition, the seller list table typically contains multiple sets and or the list itself is multiplied to a plurality of the seller list tables. These multiple tables are optionally implemented as linked lists, which are also optionally linked to the seller account table as indicated by arrows.

In FIG. 5B, a table illustrates an exemplary data structure or record for the for-sale items as used in one method of event-driven targeted advertisement according to the current invention. In one implementation, the for-sale item table of FIG. 5B is an expanded view of the for-sale item in the seller list of FIG. 5A. For Example, each of the for-sale items optionally includes any combination of a type, a product ID, a price, a discount, incentives, inventory, shipping and so on. The type further includes categories such as product, service, event and so on. The product ID uniquely identifies a particular for-sale item by any combination of a name, a model number, a manufacturer or a service provider and so on. The price indicates a sale price in dollar amount. The discount indicates a discount percentage value or a discounted amount of the for-sale item. The incentives indicate availability of other incentives such as coupons and promotions for a particular for-sale item. The inventory indicates availability of a particular for-sale item including the number of available units and their locations. Lastly, the shipping indicates a shipping cost in dollar amount and a shipping time frame. Although the for-sale item table illustrates a single set of a type, a product ID, a price, a discount, incentives, inventory and shipping, the for-sale item table optionally contains multiple sets and or the for-sale item table is multiplied to a plurality of for-sale item tables. These tables are optionally implemented as linked lists, which are linked to the corresponding seller list.

Now referring to FIG. 5C, a table illustrates an exemplary data structure or record for advertisement (AD) as used in one method of event-driven targeted advertisement according to the current invention. In one implementation, the AD table of FIG. 5C is an expanded view of the AD in the seller list of FIG. 5A. For Example, each of Ads optionally includes any combination of a medium, a message, related items and so on. The medium indicates a type of medium through which advertisement or commercial message is delivered and includes paper, e-mail, text, audio, video, web-site and so on. The message includes a pointer or pointers as indicated by an arrow to files that store contents of the AD in certain predetermined data formats. The related items include a pointer or pointers as indicated by an arrow to the for-sale items of the seller that are related to the reminder item in a certain predetermined manner.

While certain embodiments have been described above, these embodiments have been presented by way of example only and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope of the inventions.

What is claimed is:

1. A method of event-driven targeted advertisement, comprising the steps of:
allowing buyers via a reminder service to register at least one reminder item to be reminded, each of the reminder items containing buyer information at least on an item name and being associated with conditions;
allowing sellers via the reminder service to register for-sale items to be sold by the sellers, each of the for-sale items containing seller information at least on an item name and a price;
storing the reminder items, the conditions and the for-sale items at a predetermined database of the reminder service;
detecting an occurrence of at least one of the conditions;
identifying in the database at least one of the buyers and at least one of the reminder items associated with the identified buyer for each of the detected conditions;
matching the identified one of the reminder items and a substantially corresponding one of the for-sale items; and
reminding each of the identified buyers of the identified reminder items with the seller information on the matched for-sale items according to the conditions.

2. The method of event-driven targeted advertisement according to claim 1 wherein the seller information includes discounted prices of the for-sale items.

3. The method of event-driven targeted advertisement according to claim 1 wherein the seller information includes coupons for the for-sale items.

4. The method of event-driven targeted advertisement according to claim 1 wherein the seller information includes frequent user points to be offered to the buyers by the sellers.

5. The method of event-driven targeted advertisement according to claim 1 wherein the reminder items include any combination of products, material and services.

6. The method of event-driven targeted advertisement according to claim 1 wherein the conditions include any combination of trigger conditions and delivery conditions.

7. The method of event-driven targeted advertisement according to claim 6 wherein the trigger conditions include any combination of locations, time/dates and predetermined occasions.

8. The method of event-driven targeted advertisement according to claim 7 wherein the locations include any combination of GPS coordinates, predetermined stores and predetermined proximity criteria.

9. The method of event-driven targeted advertisement according to claim 7 wherein the predetermined occasions include events that are each associated with specific time and or date.

10. The method of event-driven targeted advertisement according to claim 6 wherein the delivery conditions include any combination of an address, a device, privacy, frequency, priority and a preference for the seller information.

11. The method of event-driven targeted advertisement according to claim 6 further comprising an additional step of automatically filtering the seller information based upon the delivery conditions of the identified buyers.

12. The method of event-driven targeted advertisement according to claim 1 wherein the predetermined database is under control of an intermediary agent.

13. The method of event-driven targeted advertisement according to claim 12 further comprising an additional step of manually filtering the seller information by the intermediary agent.

14. The method of event-driven targeted advertisement according to claim 1 further comprising an additional step of informing the sellers of the identified buyers and the identified reminder items.

15. The method of event-driven targeted advertisement according to claim 14 wherein said sellers selectively remind the identified buyers.

16. The method of event-driven targeted advertisement according to claim 1 wherein the reminder service reminds the identified buyers.

17. The method of event-driven targeted advertisement according to claim 1 further comprising an additional step of providing the buyers with a comparison of the prices of the matched for-sale items.

18. The method of event-driven targeted advertisement according to claim 1 further comprising an additional step of providing the buyers with an additional amount of the seller information that is related to but other than the matched for-sale items.

19. The method of event-driven targeted advertisement according to claim 1 further comprising an additional step of charging the sellers a fee.

20. The method of event-driven targeted advertisement according to claim 19 wherein the sellers pay the reminder service the fee based upon a number of the matched for-sale items.

21. The method of event-driven targeted advertisement according to claim 19 wherein the sellers pay the reminder service the fee based upon the matched for-sale items that the buyers have bought from the sellers.

22. The method of event-driven targeted advertisement according to claim 1 further comprising an additional step of charging the buyers a fee.

23. The method of event-driven targeted advertisement according to claim 22 wherein the buyers pay the reminder service the fee based upon a number of the matched for-sale items.

24. The method of event-driven targeted advertisement according to claim 22 wherein the buyers pay the reminder service the fee based upon the matched for-sale items that the buyers have bought from the sellers.

25. The method of event-driven targeted advertisement according to claim 1 further comprising an additional step of purchasing the matched for-sale items following the reminding step.

26. The method of event-driven targeted advertisement according to claim 25 wherein the buyers purchase the matched for-sale items at an internet web site of the sellers.

27. The method of event-driven targeted advertisement according to claim 25 wherein the buyers purchase the matched for-sale items at a store of the sellers.

28. The method of event-driven targeted advertisement according to claim 1 further comprising an additional step of editing the reminder items and the conditions following the reminding step.

29. The method of event-driven targeted advertisement according to claim 28 wherein the reminder items are automatically removed based upon the conditions following the reminding step.

30. The method of event-driven targeted advertisement according to claim 1 wherein the reminder items are organized into one or more of reminder lists.

31. A method of event-driven targeted advertisement, comprising the steps of:
recruiting buyers and sellers to a reminder service;
allowing the buyers to author reminder items each associated with a certain set of conditions using the reminder service;
storing the reminder lists at a predetermined database of the reminder service;
detecting an occurrence of at least one of the conditions;
identifying in the database at least one of the buyers and at least one of the reminder items based upon the detected one of the conditions;
providing selected ones of the sellers with information on the identified one of the buyers and the identified one of the reminder items; and
reminding the identified one of the buyers of the identified one of the reminder items from at least one of the selected sellers.

32. A method of event-driven targeted advertisement, comprising the steps of:
recruiting buyers and sellers to a reminder service;
allowing the buyers to author reminder items each associated with certain conditions using the reminder service;
allowing the sellers to register for-sale items using the reminder service;
storing the reminder items, the conditions and the for-sale items at a predetermined database of the reminder service;
detecting an occurrence of at least one of the conditions;
identifying in the database at least one of the buyers, at least one of the reminder items and at least one of the for-sale items based upon the detected one of the conditions; and
reminding the identified one of the buyers of the identified one of the reminder items and the identified one of the for-sale items.

33. A method of event-driven targeted advertisement, comprising the steps of:
negotiating incentives with sellers for buyers;
allowing the buyers to author reminder items each associated with a certain set of conditions;
storing the reminder items and the conditions at a predetermined database;
detecting an occurrence of at least one of the conditions;
identifying in the database at least one of the buyers and at least one of the reminder items based upon the detected one of the conditions; and
reminding the identified one of the buyers of the identified one of the reminder items with the negotiated incentives.

34. A system for event-driven targeted advertisement, comprising of:
a reminder service unit for allowing buyers to register at least one reminder item to be reminded, each of the reminder items containing buyer information at least on an item name and being associated with conditions, said reminder service unit also allowing sellers to register for-sale items to be sold by the sellers, each of the for-sale items containing seller information at least on an item name and a price; and
a plurality of terminal units operationally connected to said reminder service unit for detecting and communicating an occurrence of at least one of the conditions, wherein said reminder service unit identifying in the database at least one of the buyers and at least one of the reminder items associated with the identified buyer for each of the detected conditions, said reminder service unit matching the identified one of the reminder items and a substantially corresponding one of the for-sale items, said reminder service unit reminding each of the identified buyers of the identified reminder items with the seller information on the matched for-sale items according to the conditions.

35. The system for event-driven targeted advertisement according to claim 34 wherein the seller information includes discounted prices of the for-sale items.

36. The system for event-driven targeted advertisement according to claim 34 wherein the seller information includes coupons for the for-sale items.

37. The system for event-driven targeted advertisement according to claim 34 wherein the seller information includes frequent user points to be offered to the buyers by the sellers.

38. The system for event-driven targeted advertisement according to claim 34 wherein the reminder items include any combination of products, material and services.

39. The system for event-driven targeted advertisement according to claim 34 wherein the conditions include any combination of trigger conditions and delivery conditions.

40. The system for event-driven targeted advertisement according to claim 39 wherein the trigger conditions include any combination of locations, time/dates and predetermined occasions.

41. The system for event-driven targeted advertisement according to claim 40 wherein the locations include any combination of GPS coordinates, predetermined stores and predetermined proximity criteria.

42. The system for event-driven targeted advertisement according to claim 40 wherein the predetermined occasions include events that are each associated with specific time and or date.

43. The system for event-driven targeted advertisement according to claim 39 wherein the delivery conditions include any combination of an address, a device, privacy, frequency, priority and a preference for the seller information.

44. The system for event-driven targeted advertisement according to claim 34 wherein the predetermined database is under control of an intermediary agent.

45. The system for event-driven targeted advertisement according to claim 44 wherein said intermediary agent manually filtering the seller information.

46. The system for event-driven targeted advertisement according to claim 39 wherein said reminder service unit automatically filters the seller information based upon the delivery conditions of the identified buyers.

47. The system for event-driven targeted advertisement according to claim 34 wherein said reminder service unit informs the sellers of the identified buyers and the identified reminder items.

48. The system for event-driven targeted advertisement according to claim 47 wherein said sellers remind the identified buyers.

49. The system for event-driven targeted advertisement according to claim 34 wherein said reminder service unit reminds the identified buyers.

50. The system for event-driven targeted advertisement according to claim 34 wherein said reminder service unit provides the buyers with a comparison of the prices of the matched for-sale items.

51. The system for event-driven targeted advertisement according to claim 34 wherein said reminder service unit provides the buyers with an additional amount of the seller information that is related to but other than the matched for-sale items.

52. The system for event-driven targeted advertisement according to claim 34 wherein said reminder service unit charges the sellers a fee.

53. The system for event-driven targeted advertisement according to claim 52 wherein the sellers pay the reminder service the fee based upon a number of the matched for-sale items.

54. The system for event-driven targeted advertisement according to claim 52 wherein the sellers pay the reminder service the fee based upon the matched for-sale items that the buyers have bought from the sellers.

55. The system for event-driven targeted advertisement according to claim 34 wherein said reminder service unit charges the buyers a fee.

56. The system for event-driven targeted advertisement according to claim 55 wherein the buyers pay the reminder service the fee based upon a number of the matched for-sale items.

57. The system for event-driven targeted advertisement according to claim 55 wherein the buyers pay the reminder service the fee based upon the matched for-sale items that the buyers have bought from the sellers.

58. The system for event-driven targeted advertisement according to claim 34 wherein said terminal units provide an interface for purchasing the matched for-sale items.

59. The system for event-driven targeted advertisement according to claim 58 wherein said interface allows the buyers to purchase the matched for-sale items at an internet web site of the sellers.

60. The system for event-driven targeted advertisement according to claim 58 wherein said interface assists the buyers to purchase the matched for-sale items at a store of the sellers.

61. The system for event-driven targeted advertisement according to claim 34 wherein said terminal unit provides an interface for editing the reminder items and the conditions following the reminding step.

62. The system for event-driven targeted advertisement according to claim 61 wherein the reminder items are automatically removed based upon the conditions.

63. The system for event-driven targeted advertisement according to claim 34 wherein said terminal units provide an interface for organizing the reminder items into one or more of reminder lists.

64. The system for event-driven targeted advertisement according to claim 34 wherein said reminder service unit stores any combination of the reminder items, the conditions and the for-sale items in a predetermined database.

65. The system for event-driven targeted advertisement according to claim 34 wherein said terminal units store any combination of the reminder items, the conditions and the for-sale items in a predetermined database.
